(19) United States
(12) Patent Application Publication
(10) Pub. No.: US 2021/0248925 A1
(43) Pub. Date: Aug. 12, 2021

(54) RESUSCITATION DUMMY

(71) Applicant: ResuSciTec GmbH, Freiburg (DE)

(72) Inventors: Domagoj Damjanovic, Emmendingen (DE); Christian Scherer, Freiburg (DE); Jan-Steffen Pooth, Freiburg (DE); Sam Joé Brixius, Freiburg (DE)

(21) Appl. No.: 17/272,625

(22) PCT Filed: Aug. 9, 2019
(86) PCT No.: PCT/EP2019/071453

§ 371 Date: Mar. 1, 2021

(30) Foreign Application Priority Data
Aug. 28, 2018 (DE) 10 2018 120 960.6

(51) Int. Cl. G09B 23/28

(52) U.S. Cl. CPC G09B 23/288

(57) ABSTRACT

The invention relates to a resuscitation dummy for the practical training of resuscitation measures, comprising a dummy body, which models the human torso and in which a first fluid line system is arranged, which models the human blood circulation system in schematised form and comprises arterial and venous fluid line segments that can be associated with the human abdomen and groin area, which fluid line segments are fluidically connected to a pump.

The invention is characterised in that: the pump is a mechanical pump that can be manually actuated and that is arranged within the dummy body, which is formed from one or more parts, in the area of the human sternum, the dummy body being elastically deformable in said area; the dummy body has one opening each in the area of the human upper abdomen and in the area of the human right and/or left groin region, under each of which openings at least the arterial or venous fluid line segment partly runs and in each of which openings a body that can be physically examined sonographically and punctured is arranged; the first fluid line system and the pump are fluidically connected to a second fluid line system, along which at least one fluidic interface is arranged; and a dummy head modelling the human head is attached to the dummy body, the dummy head having a mouth-like opening, which is fluidically connected to a bag modelling the human lung.

### TECHNICAL FIELD

The invention relates to a resuscitation dummy for the practical training of resuscitation measures, comprising a dummy body, which models the human torso and in which a fluid line system is arranged, which models the human blood circulation system in schematised form and comprises arterial and venous fluid line segments that can be associated with the human abdomen and groin area, which fluid line segments are fluidically connected to a pump.

In the field of resuscitation, the results of recent years have shown that the reduction of the duration of cardiac and circulatory arrest, i.e. no-flow time, has a considerable influence on the survival and the neurological therapy success (outcome) of resuscitation patients. A minimum of no-flow time can only be achieved if everyone involved in resuscitation measures is in perfect control of their role and the procedures are coordinated with the measures taken by other team members. This can only be achieved through appropriate training. With the mention of extracorporeal cardio-pulmonary resuscitation in the current guidelines, a highly invasive procedure has been incorporated into the advanced resuscitation algorithm. The integration of cannulation during high quality conventional resuscitation with minimal no-flow time and the parallel performance of all advanced resuscitation measures places completely new demands on team training and the associated simulation. A training dummy should include the possibility of practising cannulation as “single task” training, but should also allow for the representation of the highly complex overall situation.

### PRIOR ART

Known resuscitation dummies allow either the practice of resuscitation, for example including intubation, thoracic compression, placement of intravenous accesses, simulation of defibrillation, etc., or the practice of pure cannulation with subsequent connection of a pump to a closed system.

Known resuscitation dummies for practising pure resuscitation are described, for example, in documents EP 1 623 403 B1, EP 2 430 628 B1 or in WO 1994/05000 A1 and typically comprise a mannequin-like modelling of the human upper body with head, through whose mouth and nose openings artificial respiration can be administered in continuous alternation with cardiac massage. These model mannequins, which are modelled in schematised form on the human body, are designed in such a way that they are able to give the person practising on the model mannequin as realistic a haptic impression as possible when performing artificial respiration and cardiac massage.

Document EP 1 230 634 B1 describes a device for simulating mouth-to-mouth resuscitation and cardiac massage, on which the defibrillation process can also be practised. The mannequin-like model of the human upper body and head area for this purpose has electrodes attached to the flexible breast plate.

A known resuscitation dummy for practicing cannulation can be found in document WO 2017/127724 A1 and features a human body dummy that comprises the upper body and groin areas. Within the body dummy, which is mainly made of silicone, fluid lines are laid out which model the human arterial and venous blood circulation systems in highly schematised form and which are connected, driven by a pump, to an extracorporeal fluid reservoir via a groin segment. For the purpose of puncture and cannulation, so-called cannulation windows are provided in the chest, neck and right groin area, under which windows the arterial and venous fluid line segments are arranged. The puncture and the insertion of medical instruments into the fluid line system can be practised with the known simulation device, and the flow changes within the fluid line system resulting from the cannulation can be detected and monitored.

In addition, such training mannequins enable the training of cannulation procedures for the purpose of establishing a fluidic connection to an extracorporeal fluid circuit, along which, for example, an extracorporeal membrane oxygenation machine (ECMO) may be contained. Such resuscitation dummies are known in the literature and on the market as ECMO trainers or ECMO resuscitation mannequins.

### DISCLOSURE OF THE INVENTION

The object of the invention is to further develop a resuscitation dummy for the practical training of resuscitation measures, comprising a dummy body, which models the human torso and in which a first fluid line system is arranged, which models the human blood circulation system in schematised form and comprises arterial and venous fluid line segments that can be associated with the human abdomen and groin area, which fluid line segments are fluidically connected to a pump, in such a way that a continuous simulation of all resuscitation scenarios are to be performed on a single resuscitation dummy. The possible resuscitation scenarios shall comprise the following measures: basic life support (BLS), comprising resuscitation measures such as mouth-to-mouth resuscitation or mouth-to-nose resuscitation, and also cardiac massage, professional cardiopulmonary resuscitation with use of mechanical resuscitation aids, for example in the form of mechanical systems for practising chest compressions, extracorporeal cardiopulmonary resuscitation (eCPR), comprising the implantation of an extracorporeal support system.

The novel resuscitation mannequin is intended to provide simulation training for all persons involved in the resuscitation measures, i.e. laypersons, emergency doctors, perfusionists, rescue service and other medical personnel.

The solution to the problem forming the basis of the invention is described in claim 1. Claims 12 and 13 relate respectively to a system for the practical training of resuscitation measures using a resuscitation dummy according to the solution. Features which further develop the inventive concept in an advantageous way are the subject matter of the dependent claims and of the further description, in particular with reference to the embodiments.

The resuscitation dummy constituting the solution according to the features of the preamble of claim 1 is characterised in that the pump fluidically connected to the first fluid line system is a pump that can be manually actuated and that is arranged within the dummy body, which is formed from one or more parts, in the area of the human sternum. The dummy body is elastically deformable in the area of the sternum in order to actuate the pump by exerting force or pressure on the dummy body from the outside. The dummy body has one opening each in the area of the human upper abdomen and in the area of the human right and/or left groin region, under each of which openings at least the arterial or venous fluid line segment of the first fluid line system partly runs and in each of which openings a body that can be physically examined sonographically and punctured is arranged or inserted. In addition, the first fluid line system and the pump are fluidically connected to a second fluid line system, along which at least one fluidic interface is arranged. Lastly, a dummy head modelling the human head is attached to the dummy body, the dummy head having a mouth-like opening, which is fluidically connected to a bag modelling the human lung.

The dummy head, which is fixedly or removably attached to the dummy body, serves with the mouth-like opening provided there as well as optionally additionally provided nostril openings for practising mouth-to-mouth resuscitation or mouth-to-nose resuscitation or mask-bag resuscitation via a face mask, which is characterised by the most realistic possible haptics with regard to the respiratory resistance during inspiration as well as the restoring force which is applied during expiration. For this purpose, at least the mouth-like opening is connected to at least one bag modelling the human lung via at least one air-conducting channel. In addition, the filling pressure of the bag, which extends into the region of the sternum within the dummy body, i.e. the thoracic cavity, and is fluidically connected via the at least one air-conducting channel to the mouth-like opening and optionally to the nostril openings, which filling pressure is generatable and perceptible by the resuscitation, is co-determined by the limited volume present within the dummy body.

The modelling of the mouth-like opening and of the air-conducting channel are designed inside the dummy head in such a way that they anatomically model the upper airways up to below the larynx in order to make it possible to practise introducing airway aids, i.e. different types of ventilation tubes, into the throat (larynx mask LM, larynx tube LT) or via the larynx into the trachea (endotracheal tube, ETT), respectively without (LM, LT) and with (ETT) additional instruments (laryngoscope), as realistically as possible. To monitor the success of the procedure, the breathing sounds can be listened to using a stethoscope. This part of the emergency care, which goes beyond mouth-to-mouth or mouth-to-nose resuscitation or resuscitation with a face mask and bag (“bag-mask resuscitation”), is generally referred to as extended airway management.

In the absence of extended airway management, a correct head and neck position is also necessary for technically correct and successful mouth-to-mouth resuscitation or mouth-to-nose resuscitation or mask-bag resuscitation, i.e. the lower jaw must be tilted up (mandibular protrusion) and the head/neck must be tilted back (reclination). A lack of these measures can make successful ventilation impossible. This condition is solved in the dummy head by means of a blocking mechanism which compresses the air-guiding tube in the absence of reclination/mandibular protrusion.

The mechanical pump, which is mounted in line with the sternum within the thoracic cavity of the dummy body, is designed and arranged in such a way that it can be actuated by a uniaxial, shock-like application of pressure, caused by a force directed vertically from top to bottom onto the sternum of a resuscitation dummy lying horizontally on its back, and provides a haptically perceptible mechanical resistance which largely corresponds to the situation of a cardiac massage that can be performed on a human being.

The resuscitation dummy providing the solution according to the invention thus comprises all features for carrying out simulated ventilation and cardiac massage.

The manually actuatable, mechanical pump is able to establish a directed pulsatile system flow within the first fluid line system depending on the actuation of the pump, which system flow comes to a standstill if the mechanical pump is not actuated. The mechanical properties of the pump, such as compression depth, pressure point, independent, relieving return of the pump to its initial state as well as the operation of the mechanical pump, i.e. the frequency of the compression force manually acting on the pump, have a decisive influence on the system flow generated within the first fluid line system. The system flow within the arterial and venous fluid line segments of the first fluid line system can also be detected with the aid of an external mobile ultrasound unit and can be made visible and tangible by means of suitable imaging procedures for the persons training on or with the resuscitation dummy.

The resuscitation dummy provides openings in the area of the human upper abdomen and in the area of the human right and/or left groin region for the purpose of, to the greatest possible extent, a loss-free ultrasound wave coupling to the arterial and venous fluid line segments of the first fluid line system, which openings are each covered or filled with a body that can be physically examined sonographically, preferably consisting of medical synthetic gel. In principle, alternative materials are also suitable for covering or filling the openings provided in the dummy body, such as ballistic gelatine or the like, which have properties that can be physically examined sonographically. Furthermore, it is also possible to haptically perceive the pulsatile system flow established by the pump within the first fluid line system by means of the tactilely perceptible pressure waves via the medically synthetic gel or similar elastic material.

The bodies that can be examined sonographically and punctured are preferably non-transparent, so that they cover the fluid line segments running inside the dummy body invisibly for persons practising on the resuscitation dummy.

The puncture procedure and the subsequent cannulation are preferably carried out with ultrasound support, so that the person concerned can practice handling both a puncture or cannulation instrument and an ultrasound probe for visual representation of the injection or cannulation procedure on the basis of an ultrasound image. The resuscitation dummy, in this regard, offers the possibility to perform puncture and cannulation on at least two different areas of the dummy body in order to be able to experience different puncture situations as well as their direct effect on the system flow. In this way, in addition to cannulation experiences that are as realistic as possible, qualitative aspects of resuscitation and, above all, their interactions and dependencies, such as the compression depth, pressure point and frequency of compression already mentioned above, all of which have a decisive influence on the system flow, can be better portrayed.

The use of a mobile ultrasound device, the ultrasound probe of which, in the area of the openings, is placed on the surface of one of the bodies that can be examined sonographically, generates ultrasonic sectional images of the fluid line segments which run directly under or in the body that can be examined sonographically and which are to be punctured.

In an extended embodiment, an electrically, magnetically or electromagnetically detectable unit is arranged within the dummy body in the area of at least one of the openings, preferably in the form of an RFID chip, in order to be able to dispense with the need for a real ultrasound device on the one hand (in such a case, the puncture procedure is displayed virtually on an ultrasound simulation device, triggered by the detectable unit), and on the other hand in order to be able to virtually generate and visually display the representation and perceptibility of further intracorporeal areas of the resuscitation dummy. In particular by using RFID technology, it is possible to simulate the findings for a heart, reversible causes of a cardiovascular condition, puncture needle and/or cannula malpositions, therapy controls, etc. With the help of an externally manageable RFID antenna, which is manually guided over the resuscitation dummy in the area of the openings or other body regions (“regions of interest”), it is possible to detect the detectable unit, which is designed as an RFID chip, from which any stored or programmable information can be called up and can be visually presented to the person concerned in a suitable way or trigger such a visual presentation on a suitable display device.

Above all, however, the resuscitation dummy, which is designed in accordance with the solution, makes it possible to practise performing extracorporeal cardiopulmonary resuscitation, or eCPR for short, which, according to 2015 guidelines, must be considered if primary resuscitation efforts have failed or special interventions are necessary to eliminate reversible causes.

For this purpose, the resuscitation dummy provides at least one fluidic interface along the second fluid line system, to which an extracorporeal fluid circuit can be fluidically coupled, which contains at least one of the following components: fluid reservoir, fluidic open-loop and/or closed-loop control unit for presetting and/or varying an absolute and/or pulsative fluid flow pressure within the first fluid line system, degassing unit.

By providing a second fluid line system connected in parallel to the first fluid line system, which second fluid line system can be connected to an open reservoir or to a fluidic system that is controllable by open-loop or closed-loop control, for example for the simulation of a patient, different variable pressures can be specified in the entire fluid line system, in particular in the first fluid line system, along which the puncturing and cannulation areas are contained, and realistic resuscitation scenarios which extend beyond the time of cannulation can be generated and simulated. By connecting a fluidic open-loop and/or closed-loop control unit, by which the absolute and/or pulsatile fluid flow pressure within the first fluid line system can be individually specified, specific medical scenarios can be simulated which may occur during resuscitation. In particular, earlier perfusion phases as well as combination scenarios regarding the handling of the extracorporeal circulation which are primarily problematic from a cardiotechnical point of view, such as the suction of the venous cannula in the event of vasoplegia, can be simulated and practised in this way.

### BRIEF DESCRIPTION OF THE INVENTION

The invention is described below without limitation of the general concept of invention by means of embodiments with reference to the drawings, in which:

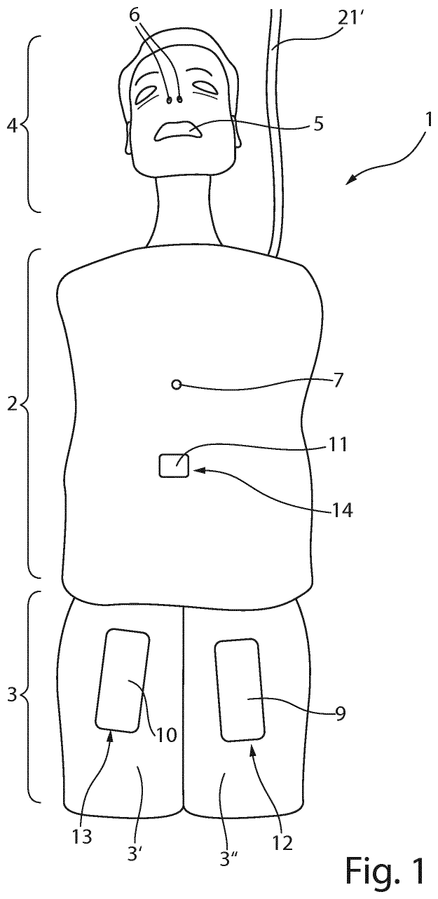

FIG. 1 shows a plan view of a resuscitation dummy designed according to the solution,

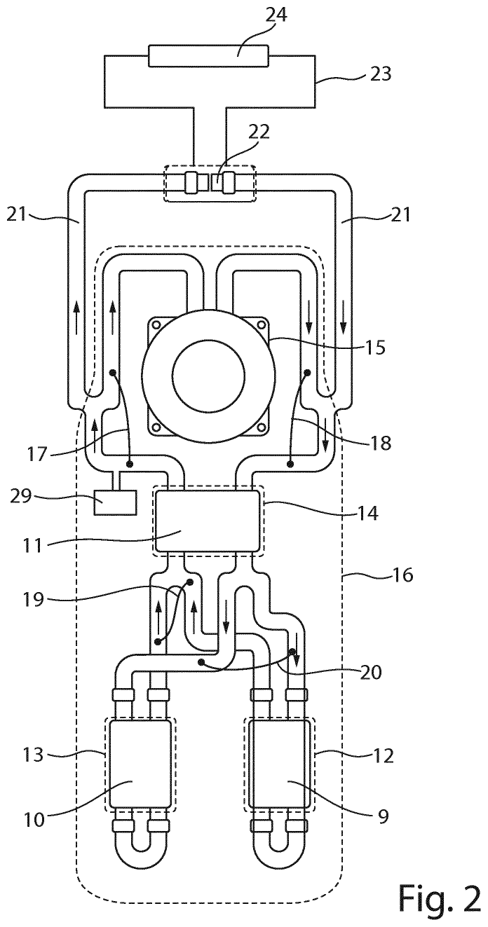

FIG. 2 shows a representation of the first and second fluid line system with mechanical pump, and

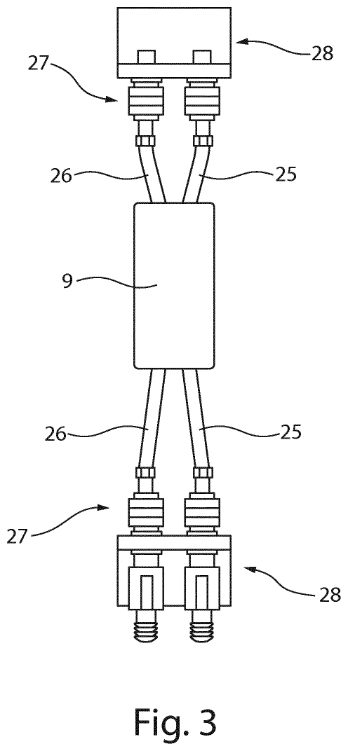

FIG. 3 shows fluid couplings with modular exchangeable fluid line segment.

### EMBODIMENTS OF THE INVENTION, INDUSTRIAL APPLICABILITY

FIG. 1 shows a plan view of a resuscitation dummy 1, which is designed according to the solution and which comprises a dummy body 2, which models the human torso, and a groin area 3, which is directly connected to the dummy body and which comprises a left and right upper thigh area 3′, 3″. A dummy head 4 is attached to the shoulder area of the dummy body 2 and has a mouth-like opening 5 and two nostril openings 6, which are fluidically connected to the mouth-like opening 5.

For the purpose of carrying out mouth-to-mouth resuscitation as realistically as possible, the mouth-like opening 5 and the nostril openings 6 are fluidically connected via at least one air channel running inside the dummy head 4 and dummy body 2 to a bag modelling the human lung, which bag is arranged in the region of the sternum 7.

Before reference is made to the openings 12, 13, 14 within the dummy body 2 and the right and left upper thigh areas 3′, 3″ shown in FIG. 1, which openings are each closed with a body 9, 10, 11 that can be examined sonographically and punctured, reference is made to the explanation of the fluid line system located inside the resuscitation dummy 1 and illustrated in FIG. 2.

FIG. 2 illustrates the fluid line system arranged within the resuscitation dummy. The central component is a manually actuatable, mechanical pump 15, which is located inside the dummy body 2 in the area of the human sternum 7. Fluidically connected to the manually actuatable pump 15 is a first fluid line system 16, which is framed by a dashed line in FIG. 2. The first fluid line system 16 models the human blood circulation system in schematised form and is composed of venous 17 and arterial 18 fluid line segments that can be associated with the human abdomen as well as venous 19 and arterial 20 fluid line segments that can be associated with the human groin area. For the purpose of puncturing and cannulation, arterial and venous fluid line segments are arranged in the region of the abdomen below the opening 14 shown in FIG. 1 and in the left and right upper thigh area 3′, 3″ below the openings 12, 13 shown in FIG. 1, where possible in accordance with the human anatomy with regard to shape, size and relative spatial arrangement. In FIG. 2, these areas are covered by the bodies 9, 10, 11 that can be examined sonographically and punctured, these bodies also being shown in FIG. 1.

When the pump 15 is actuated, a flow oriented by the arrows shown in FIG. 2 is impressed along the first fluid line system 16 and flows, starting from the pump 15, firstly through the arterial fluid segments 18, 20 and then through the venous fluid segments 19, 17.

In the area of the venous and arterial fluid line segments 17, 18, which can be associated with the abdomen, there is fluidically connected a second fluid line system 21 which, parallel to the first fluid line system 16, is likewise fed and also passed through by a fluid flow, driven by the manually actuatable pump 17. A fluidic interface 22 is introduced along the second fluid line system 21, to which fluidic interface an extracorporeal fluid circuit 23 can be coupled. Along the extracorporeal fluid circuit 23, at least one component 24 of the following components can be fluidically coupled outside the resuscitation dummy 1: fluid reservoir, fluidic open-loop and/or closed-loop control unit for presetting and/or varying an absolute and/or pulsatile fluid flow pressure within the first fluid line system, degassing unit, patient simulator.

The second fluid line system 21 shown in FIG. 2 is indicated in FIG. 1 by the lines 21′ leading away from or leading to the resuscitation dummy 1.

In the knowledge of the first and second fluid line systems 16, 21 illustrated in FIG. 2, and the manually actuatable mechanical pump 15 fluidically connected to them, puncture and cannulation procedures can be carried out on the resuscitation dummy 1 shown in FIG. 1 in the following manner:

The openings 12, 13 and 14 are completely covered by the bodies 9, 10, 11 that can be examined sonographically and punctured and that are made of non-transparent material. This creates the most realistic situation possible. For the exact location of the fluid line segments to be punctured, which are located directly below the bodies 9 to 11, a conventional mobile ultrasonic device is preferably suitable. Since the bodies 9, 10, 11 that can be examined sonographically are preferably made of a medical synthetic gel, this will hardly cause any artefacts or disturbances in the ultrasonic locating. The person in charge of puncture and cannulation can always perform ultrasound-monitored vascular puncture in the area of openings 12 and 13 and can check the position of the wire and cannulas. Typically, no puncture is performed in the area of opening 14, and instead the position of a guide wire is checked here with the aid of an ultrasound probe, which is placed in the area of openings 12, 13 after a puncture and is advanced along the fluid lines.

As an alternative or in combination with the performance of an ultrasound-monitored puncture and cannulation, an RFID chip can be arranged in the area of at least one of the openings 12, 13, 14 and can be detected by a simulated transducer with RFID antenna. Instead of a live image of the body area detected by a real ultrasound probe, an ultrasound device can be simulated with the aid of RFID technology and, in conjunction with sectional images stored on a data carrier, can be visually displayed on a suitable visual display unit. In addition, further RFID chips can be attached at suitable locations within the dummy body, which makes it possible to increase the complexity of medical exercises, for example by adding complex combinations of findings or pathologies.

In order to keep the preparation of the resuscitation model between multiple applications as short and simple as possible, the punctured and thus leaking fluid line segments must be replaced as quickly and easily as possible. FIG. 3 shows a preferred design for rapid modular replacement of punctured fluid line segments 25, 26, along which a body that can be examined sonographically and punctured, preferably in the form of a medical synthetic gel 9, 10, is arranged. In this way, the punctured fluid line segments 25, 26 together with the body, for example 9, which surrounds the fluid line segments like a matrix, can be separated from the rest of the fluid line system via ball valve quick-action couplings 27 and can be replaced by new fluid line segments together with the body.

Such a modular design also facilitates re-venting after the puncture site has been replaced and limits or reduces to a minimum the amount of consumables required when using the resuscitation dummy according to the solution.

For user-friendly handling and a positionally fixed locking of the quick-action couplings 27 as well as the associated fixed positioning of the puncturable fluid line segments 25, 26, the quick couplings 27 are fixed inside the dummy body 1 by means of corresponding holders 28.

In a preferred embodiment, the resuscitation dummy provides an elastic fluid reservoir 29 on the side of the venous fluid line segments in order to prevent collapse of these venous fluid line segments during the use of a resuscitation aid and additionally to realise the simulation of a central venous pressure (CVP) in combination with a fluidic component 24 integrated within the additional extracorporeal circuit 23. Furthermore, this reservoir 29 is used to automatically eliminate air bubbles from the fluid system.

### LIST OF REFERENCE SIGNS

1 resuscitation dummy
2 dummy body
3 groin area
3′ right upper thigh area
3″ left upper thigh area
4 dummy head
5 mouth-like opening
6 nostril opening
7 sternum
8 N.N.
9, 10, 11 body that can be examined sonographically and punctured
12, 13, 14 opening
15 manually actuatable pump
16 first fluid line system
17 venous fluid line segment that can be associated with the abdomen
18 arterial fluid line segment that can be associated with the abdomen
19 venous fluid line segment that can be associated with the groin area
20 arterial fluid line segment that can be associated with the groin area
21 second fluid line system
21′ supply line, return line
22 fluidic interface
23 extracorporeal liquid circuit
24 component
25, 26 puncturable fluid line segment
27 quick-action coupling ball coupling
28 mechanical holder
29 elastic reservoir

1. A resuscitation dummy for the practical training of resuscitation measures, comprising a dummy body, which models the human torso and in which a first fluid line system is arranged, which models the human blood circulation system in schematised form and comprises arterial and venous fluid line segments that can be associated with the human abdomen and groin area, which fluid line segments are fluidically connected to a pump,
wherein the pump is a mechanical pump that can be manually actuated and that is arranged within the dummy body, which is formed from one or more parts, in the area of the human sternum, the dummy body being elastically deformable in said area, the dummy body has one opening each in the area of the human upper abdomen and in the area of the human right and/or left groin region, under each of which openings at least the arterial or venous fluid line segment partly runs and in each of which openings a body that can be physically examined sonographically and punctured is arranged,
the first fluid line system and the pump are fluidically connected to a second fluid line system, along which at least one fluidic interface is arranged, and
a dummy head modelling the human head is attached to the dummy body, the dummy head having a mouth-like opening, which is fluidically connected to a bag modelling the human lung.

2. The resuscitation dummy according to claim 1,
wherein at least one of the following components is fluidically connected or connectable to the fluidic interface:
fluid reservoir, fluidic open-loop and/or closed-loop control unit for presetting and/or varying an absolute and/or pulsatile fluid flow pressure within the first fluid line system, degassing unit.

3. The resuscitation dummy according to claim 1, wherein an electrically, magnetically or electromagnetically detectable unit is implemented at least in the area of one of the openings within the dummy body.

4. The resuscitation dummy according to claim 3, wherein the unit is an RFID chip which is detectable by an externally manageable RFID antenna.

5. The resuscitation dummy according to claim 1, wherein
the body that can be physically examined sonographically and punctured comprises medicinal synthetic gel.

6. The resuscitation dummy according to claim 1, wherein the venous and/or arterial fluid line segments penetrate the body that can be physically examined sonographically and punctured.

7. The resuscitation dummy according to claim 1, wherein two fluid couplings are arranged at a distance from one another along the arterial and/or venous fluid line segment in such a way that the fluid line segment can be replaced section by section in the region of an opening.

8. The resuscitation dummy according to claim 7, wherein the fluid couplings are fixedly or releasably connected to the dummy body.

9. The resuscitation dummy according to claim 1, wherein the dummy head is attached fixedly or removably fixedly to the dummy body, and
in that the bag modelling the human lung extends into the region of the sternum inside the dummy body and is surrounded so as to be delimited thereby in such a way that, during resuscitation, realistic haptics can be modelled with regard to resuscitation resistance and a restoring force as a function of a filling pressure inside the bag.

10. The resuscitation dummy according to claim 1, wherein
the second fluid line system is fluidically connected indirectly or directly to the pump and parallel to the first fluid line system, and
in that the second fluid line system has a fluid line segment running outside the dummy body, along which second fluid line system the fluidic interface is arranged.

12. A system for the practical training of resuscitation measures with a resuscitation dummy according to claim 1, wherein a diagnostic ultrasound probe is provided, the ultrasound waves of which are able to propagate through the body that can be physically examined sonographically and punctured and are able to detect the arterial and/or venous fluid line segment, and
in that, by means of a puncture needle, the detected fluid line segment can be punctured through the body that can be physically examined sonographically and punctured.

13. A system for the practical training of resuscitation measures with a resuscitation dummy according to claim 1, wherein a detector is provided for detecting the electrically, magnetically or electromagnetically detectable unit, and
in that the detector is connected indirectly or directly to an output unit for the visual, acoustic and/or haptically perceptible representation of information transmitted between the detector and the detectable unit.
